(19) United States
(12) Patent Application Publication
(10) Pub. No.: US 2026/0261183 A1
(43) Pub. Date: Sep. 3, 2026

(54) POWER GENERATION DEVICE

(71) Applicant: TET ENERGY GmbH, Egelsbach (DE)

(72) Inventor: Karl SALZMANN, Ginsheim-Gustavsburg (DE)

(21) Appl. No.: 19/163,266

(22) PCT Filed: Oct. 28, 2024
(86) PCT No.: PCT/EP2024/000058

§ 371 Date: Sep. 8, 2025

(30) Foreign Application Priority Data
Nov. 7, 2023 (DE) 10 2023 130 832.7

(51) Int. Cl. H02K 7/075; F16C 3/08

(52) U.S. Cl. CPC H02K 7/075; F16C 3/08

(57) ABSTRACT

A power generating device includes a plurality of cylindrical coil windings or one or more coil winding packs that enclose an interior space in which one or more annular permanent magnets or permanent magnet packs is arranged. The coil windings arranged next to one another are wound alternately to the right and to the left and the permanent magnets are arranged next to one another with the same polarity as one another. The number of coil windings is even and the number of permanent magnets is odd.

The invention relates to a power generation device comprising a plurality of cylindrical coil windings or one or more coil winding packs that enclose an interior space in which one or more ring-shaped, axially magnetized permanent magnets or permanent magnet packs are arranged in a coaxially movable and driveable manner.

It is therefore an object of the invention to provide a power generation device of the type mentioned at the outset which has a simple and cost-effective construction of small structural volume and a high efficiency.

This object is achieved according to the invention in that the coil windings arranged next to one another are wound alternately to the right and to the left and the permanent magnets are arranged with the same polarity as one another, wherein the number of coil windings is even and the number of permanent magnets is odd.

This design achieves a very high number of volts.

The power generation device according to the invention generates clean, 100% CO₂ pollutant-free power.

In order that the permanent magnets do not move away from one another, the number of permanent magnets can be braced axially to form a permanent magnet pack.

This is possible in a simple manner by the number of permanent magnets being braced axially to form a permanent magnet pack by means of a screw connection.

The coil windings are preferably arranged at predetermined axial distances from one another and the permanent magnets are preferably arranged at predetermined axial distances from one another.

In order that an overlapping of coil windings and permanent magnets is always present in a power-increasing manner, the axial distances of the coil windings can correspond to the distances of the permanent magnets and the width of the coil windings can correspond to the width of the permanent magnets, wherein the width of the coil windings and permanent magnets is greater than the distances between coil windings and permanent magnets.

To ensure the distances between the coil windings and/or the permanent magnets, the distances can be predetermined in a simple manner by means of non-magnetic spacer rings between the coil windings and/or permanent magnets.

A construction requiring only a small structural volume, which is low in wear and thus has a long service life and has a high degree of efficiency, is achieved in that the permanent magnet(s) or permanent magnet packs can be driven coaxially movably by means of a crank of a crankshaft coaxially with respect to the coil windings or the coil winding packs and the crankshaft can be driven rotatably about an axis of rotation by means of a drive.

The crankshaft driveable rotatably by a drive can have at least a first crank and a second crank, wherein the first crank and the second crank extend radially away from the crankshaft offset by an angle with respect to one another, and wherein the coil winding or the coil winding pack can be driven coaxially movably by the first crank, the permanent magnet or the permanent magnet pack can be driven coaxially movably by the second crank.

Due to the movement of the coil winding and permanent magnet in opposite directions, a double stroke of action is achieved with a doubled relative speed of the coil winding and permanent magnet and thus a double inductance and double the number of volts.

The movement in opposite directions achieves a double effective total stroke, wherein each individual coil winding is touched synchronously in succession equally repeatedly by the individual permanent magnets, whereby enormous masses of alternating voltage pulses are achieved.

A particularly high degree of efficiency is achieved if the first crank and the second crank extend diametrically away from the crankshaft.

For coaxial movement, the coil winding or the coil windings and/or the permanent magnet or the permanent magnets can be guided coaxially in guides.

If the coil winding or the coil windings are arranged on a coil carrier, it is held in a positionally stable manner in a simple way.

A simple cooling of the coil winding or the coil windings is effected in that the coil winding or the coil windings are arranged in the coil carrier partially exposed radially outward.

The movement of coil winding or coil windings and permanent magnets in opposite directions results in permanent air intake and air displacement in the interior space of the coil winding or coil windings and thus in cooling of the coil winding or coil windings and permanent magnets. Power losses due to heating are thereby substantially reduced. The number of volts produced can thereby be kept largely constant.

A construction-space-saving and cost-effective embodiment consists in the coil carrier carrying two coil windings or two rows of coil windings parallel at a distance from one another and being driveable coaxially movably by a push rod.

For a stably guided movement, the coil carrier can be guided coaxially on a stationary rolling table.

The first crank can be connected to the coil carrier via a first push rod.

If the first push rod is formed coaxially in at least two parts and if two parts of the first push rod are connected to one another via a compression spring, the actual effective stroke is extended by the compression and expansion of the compression spring. Furthermore, the compression spring by its operation increases the speed of the permanent magnet entering and exiting the coil winding, thereby increasing the number of volts generated.

For the movement drive of the permanent magnet or the permanent magnets, the crank or the second crank can be connected to the permanent magnet or the permanent magnets via a push rod or second push rod, wherein the permanent magnet or the permanent magnets can be arranged on the push rod or second push rod.

If the push rod or second push rod is formed coaxially in at least two parts and if two parts of the push rod or second push rod are connected to one another via a compression spring, the actual effective stroke is produced by the compression and expansion of the compression spring.

For coaxial guidance, the push rod or second push rod can be guided coaxially at its first and second end regions in first and second guide openings of stationary first and second guide pieces, wherein the region of the push rod or second push rod having the compression spring can be guided in the first guide opening of the first guide piece.

By means of the guidance in the guide pieces, it is possible that the push rod or second push rod of permanent magnet or of the permanent magnets is guided in a floating manner with the smallest possible air gap of the permanent magnets for the coil winding. The guides can have bearings, such as axial Teflon needle bearings, which have only very low friction.

For the simple connection of the crank and the push rod while preventing the push rod from jamming in the guide piece, the free end of the first crank can be articulated on the first push rod about a pivot axis parallel to the crankshaft and/or the free end of the crank or second crank can be articulated on the second push rod about a pivot axis parallel to the crankshaft or the second pivot axis.

An exemplary embodiment of the invention is illustrated in the drawing and is described in more detail below. In the drawing:

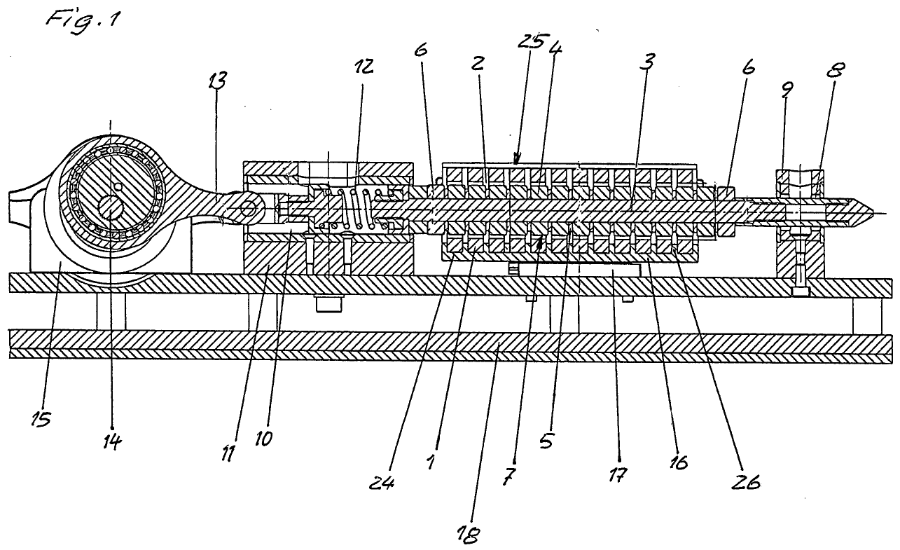

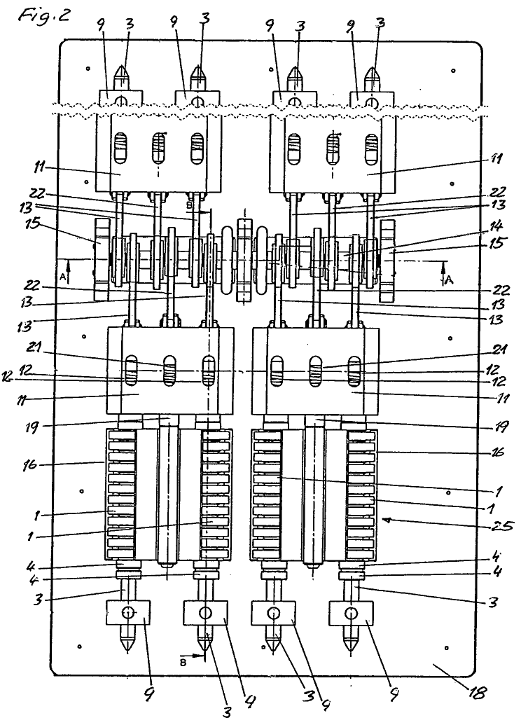

FIG. 1 shows a longitudinal section along the line B-B in FIG. 2 of a unit formed of a coil winding pack and a permanent magnet pack of a power generation device

FIG. 2 shows a plan view of a plurality Of units consisting of permanent magnet pack units and coil winding pack units of a power generation device according to FIG. 1

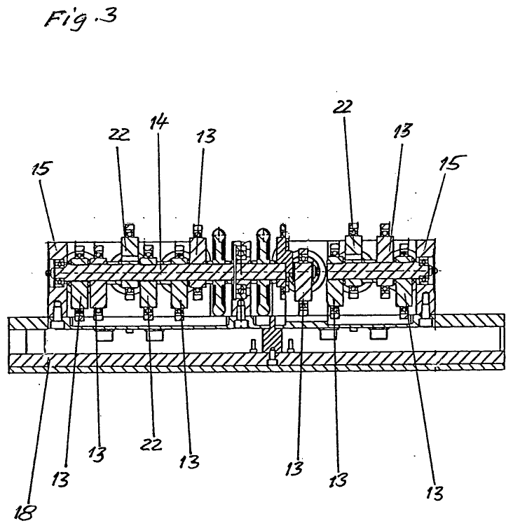

FIG. 3 shows a cross-sectional view of the power generation device taken along the line A-A in FIG. 2

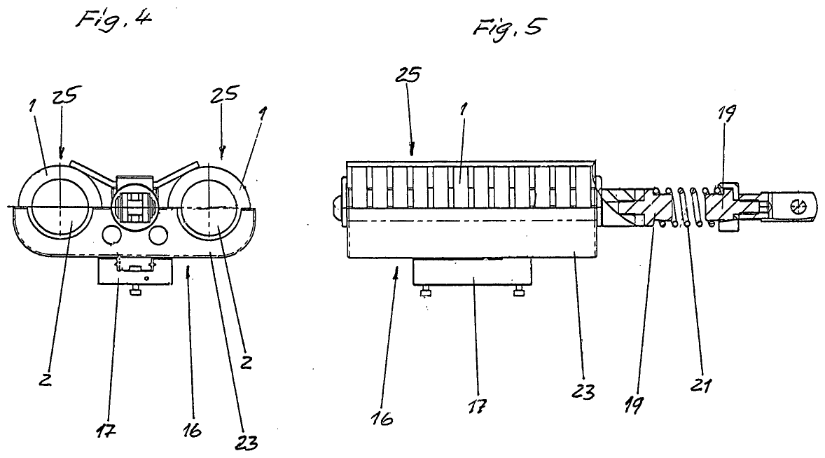

FIG. 4 shows an end view of a coil carrier of the power generation device according to FIG. 1

FIG. 5 shows a side view of the coil carrier according to FIG. 4.

The power generation device shown in the figures has a plurality of coil windings 1, each of which encloses a cylindrical interior space 2, in which a plurality of ring-shaped permanent magnets 4 are arranged next to one another on a second push rod 3 coaxially with respect to the coil winding 1. By means of non-magnetic second spacer rings 5 arranged between the individual permanent magnets 4, the permanent magnets 4 are held at predetermined axial distances from one another.

The coil windings 1 are wound alternately to the right and left.

The permanent magnets 4 are each arranged with the same polarity as one another. At the end regions of the permanent magnet pack 7, the second push rod 3 has threads onto which nuts 6 are screwed, which axially clamp the permanent magnets 4 to form the permanent magnet pack 7.

In FIG. 1, outside the permanent magnet pack 7, the right end of the second push rod 3 projects through a second guide opening 8 of a stationary second guide piece 9 and is guided therein in an axially displaceable manner.

Outside the permanent magnet pack 7, the left end of the second push rod 3 is formed in two parts and is displaceably guided through a third guide opening 10 of a stationary first guide piece 11.

Between the mutually facing ends of the two parts of the second push rod 3 a second helical compression spring 12 is arranged, which connects the two parts of the second push rod 3 to one another.

The part of the second push rod 3 which does not carry the permanent magnets is articulated at its end remote from the part carrying the permanent magnets to a second crank 13. The second crank 13 is mounted eccentrically radially on a crankshaft 14, which extends transversely to the longitudinal extension of the second push rod 3 and can be driven rotatably by a drive, not shown.

The crankshaft 14 is rotatably mounted on stationary bearing blocks 15.

As can be seen in particular in FIG. 2, two of the arrangements described above of the second push rod 3 and the permanent magnet pack 7 are arranged parallel to one another.

Between these two arrangements of second push rod 3 and permanent magnet pack 7, an arrangement with coil winding 1 is arranged parallel to these, as is shown in more detail in FIGS. 4 and 5.

In this case, two coil winding packs 25 of coil windings 1 are arranged in a coil carrier 16 parallel to one another, which packs each extend coaxially with respect to the permanent magnet packs 7. The permanent magnet packs 7 are located in each of the cylindrical inner spaces 2 of the coil winding packs 25 with only a small radial air gap to the coil windings 1 of the coil winding packs 25.

The coil carrier 16 is displaceably guided by means of a rolling table 17 on a base plate 18 of the power generation device transversely to the crankshaft 14.

At its right end in FIG. 5, a first push rod 19 is arranged parallel to the coil winding packs 25 and is formed in two parts.

The first push rod 19 is displaceably guided through a first guide opening of the stationary first guide piece 11.

Between the mutually facing ends of the two parts of the first push rod 19 a first helical compression spring 21 is arranged, which connects the two parts of the first push rod 19 to one another.

The part of the first push rod 19 facing away from the coil carrier 16 is articulated at its end facing away from the coil carrier 16 on a first crank 22 about a pivot axis parallel to the crankshaft 14. The first crank 22 is eccentrically mounted radially on the crankshaft 14.

The coil carrier 16 made of a non-magnetic material is open at its upper half remote from the roller table 17. In the lower half 23, receiving grooves 24 for receiving the coil windings 1, into which the coil windings 1 are inserted, are formed corresponding to the coil windings 1. Webs 26 formed integrally with the coil carrier 16 protrude between the individual coil windings 1, which webs hold the coil windings 1 as spacer rings at a distance from one another which corresponds to the width of the second spacer rings 5 of the permanent magnet pack 7.

The number of coil windings 1 of the coil winding packs 25 is even, while the number of permanent magnets 4 of the permanent magnet packs 7 is odd.

The first crank 22 and the second crank 13 extend away from the crankshaft 14 in opposite directions to each other, so that the coil winding packs 25 and the permanent magnet packs 7 always perform a movement in opposite directions to each other.

As shown in FIG. 2, driven by a single crankshaft 14, a plurality of units consisting of permanent magnet assembly units and coil winding assembly units can be arranged next to one another or one behind the other.

### List of Reference Signs

1 coil windings
2 interior space
3 second push rod
4 permanent magnets
5 second spacer rings
6 nuts
7 permanent magnet pack
8 second guide opening
9 second guide piece
10 third guide opening
11 first guide piece
12 second helical compression spring
13 second crank
14 crankshaft
15 bearing blocks
16 coil carrier
17 rolling table
18 base plate
19 first push rod
21 first helical compression spring
22 first crank
23 lower half
24 receiving grooves
25 coil winding pack
26 webs

1. A power generation device comprising:
a plurality of cylindrical coil windings (1) or one or more coil winding packs (25) of coil windings (1) which enclose an interior space (2) in which one or more ring-shaped, axially magnetized permanent magnets (4) or permanent magnet packs (7) are arranged in a coaxially movable and driveable manner, wherein coil windings (1) of the plurality of cylindrical coil windings (1) or the one or more coil winding packs (25) that are arranged next to one another are wound alternately to the right and to the left, the permanent magnets (4) that are arranged next to one another are arranged with the same polarity as one another, and the number of coil windings (1) in the plurality of cylindrical coil windings (1) or the one or more coil winding packs (25) is even and the number of permanent magnets (4) in the interior space (2) corresponding to the plurality of cylindrical coil windings (1) or each of the one or more coil winding packs (25) is odd.

2. The power generation device as claimed in claim 1, wherein the number of permanent magnets (4) is braced axially to form a permanent magnet pack (7).

3. The power generation device as claimed in claim 2, wherein the number of permanent magnets (4) is axially braced to form a permanent magnet pack (7) by a screw connection.

4. The power generation device as claimed in claim 1, wherein the coil windings (1) are arranged at predetermined axial distances from each other.

5. The power generation device as claimed in claim 4, wherein the permanent magnets (4) are arranged at predetermined axial distances from each other.

6. The power generation device as claimed in claim 5, wherein the axial distances of the coil windings (1) correspond to the axial distances of the permanent magnets (4) and a width of the coil windings (1) corresponds to a width of the permanent magnets (4), wherein the width of the coil windings (1) and permanent magnets (4) is greater than the axial distances between the coil windings (1) and between the permanent magnets (4).

7. The power generation device as claimed in claim 1, wherein nonmagnetic spacer rings (5) between the coil windings (1) and/or between the permanent magnets (4) space apart the coil windings (1) and/or the permanent magnets (4) by predetermined axial distances.

8. The power generation device as claimed in claim 1, further comprising a crankshaft (14) and a crank (13) configured to drive the one or more permanent magnets (4) or the permanent magnet packs (7) coaxially with respect to the plurality of coil windings (1) or the one or more coil winding packs (25), and the crankshaft (14) can be driven rotatably about an axis of rotation by a drive.

9. The power generation device as claimed in claim 1, further comprising a crankshaft (14) which can be driven rotatably by a drive, the crankshaft having at least a first crank (22) and a second crank (13), wherein the first crank (22) and the second crank (13) extend radially away from the crankshaft (14) offset by an angle with respect to one another, and wherein the plurality of coil windings (1) or the one or more coil winding packs (25) is driveable coaxially movably by the first crank (22), the one or more permanent magnets or the permanent magnet pack (7) is driveable coaxially movably by the second crank (13).
